(19) United States
(12) Patent Application Publication
(10) Pub. No.: US 2016/0221169 A1
(43) Pub. Date: Aug. 4, 2016

(54) MULTI-FUNCTION SLIDE HAMMER AND METHODS OF USE

(71) Applicants: Nathaniel LeBaron, Cedar City, UT (US); Melissa LeBaron, Cedar City, UT (US)

(72) Inventors: Nathaniel LeBaron, Cedar City, UT (US); Melissa LeBaron, Cedar City, UT (US)

(21) Appl. No.: 15/011,447

(22) Filed: Jan. 29, 2016

Related U.S. Application Data
(60) Provisional application No. 62/109,571, filed on Jan. 29, 2015.

(51) Int. Cl. B25D 1/16; E02D 7/04; A01K 1/04; B27L 7/06

(52) U.S. Cl. CPC B25D 1/16; B27L 7/06; E02D 7/04; A01K 1/04

(57) ABSTRACT

The present disclosure is directed to mechanical, hand-driven wood splitters and earth anchors. In one embodiment, a multi-function slide hammer comprises a wood-splitting wedge, a guide rod, and at least two handles connected to a sleeve that is slidable on the guide rod; wherein the handles are joined to the sleeve at a lower end and an upper end of the sleeve.

### CROSS-REFERENCE TO RELATED APPLICATIONS

This application claims the benefit of U.S. Provisional Application Ser. No. 62/109,571, filed on Jan. 29, 2015, which is incorporated herein by reference.

### TECHNICAL FIELD

The present disclosure relates to manually driven wedges. More specifically, the present disclosure relates to mechanical, hand-driven slide hammer splitters and anchors.

### BACKGROUND

Splitting wood has been done for a very long time. The traditional method involves striking a log with an object, such as an axe, in an effort to split it. The repeated swinging of the axe may cause back injuries and other problems well known in the art. As a solution to this, various devices have been invented to help reduce or remove the physical labor that must be performed. However, many of these devices are bulky, require electricity or other means to operate hydraulic mechanisms, and are often costly.

Others have attempted to simply make the physical strain less, such as by adding a wedge that is struck by a separate object (e.g., sledge hammer) with brute force. However, many of the risks and dangers remain. Others, such as U.S. Pat. No. 5,704,374, introduce a method using a striking weight connected to a rod. However, multiple rods must be used with either an additional stand or the use of a drill to secure the second rod. Therefore, there remains a need for wood splitter that does not require additional tools or power sources to utilize, is portable, and that lessens or eliminates the possibility of injury to the user.

Others have also incorporated a striking weight and rod, but problems remain. For example, a sliding weight without handles on a rod suffers from the inability of the user to maintain good grasp and control. It also lacks the ability of a user to generate additional downward force due to the unnatural travel position of the arms (directly in front of the body). Further, if the user maintains a grip, significant vibratory forces are transferred to the user's hands. There is also a risk of a finger or hand getting pinched by the sliding action. Therefore, these problems need to be overcome.

Attempting to solve these problems, others have added perpendicular handles to the slide-weight. While allowing better grip and force than the version without handles, it still fails to be an effective and safe tool. For example, when forced downward, significant force is transferred to the handles, thereby creating a large impact on the user's hands and wrists. This high-impact, whiplash-like force can cause severe pain and damage to the nerves in both the hands and the wrists. With significant force being transferred to the hands and body, it is not only painful to use, but the hammering action is less effective.

U.S. Pat. No. 5,495,878 to McKenen attempts to solve the above problems by disclosing vertical handles with horizontal handles therebetween. As described by McKenen (see Abstract), the outer sleeve has an internal weight disposed at the top of the sleeve that slams the top of the shaft (i.e., guide rod) when forced downward. This creates several disadvantages, the primary of which is the force path. In other words, with the weight positioned at the top of the sleeve and hitting the top of the rod, the force applied must travel the full length of the rod before reaching the wood. Therefore, a significant vibratory effect is created and force is lost before reaching the wood. This, in turn, leads to an extended time to split wood and other materials, as well as creating unwanted vibrations for the user, which may lead to discomfort and/or pain. Further, because the weight/hammer is at the top, force may only be applied in a downward motion. Therefore, decreasing vibration, increasing impact force, and allowing more than a downward force are all problems remaining to be solved.

Other examples in the prior art include a sliding weight/hammer disposed on the inside of a hollow shaft. However, this creates an easier ability of the unit to jam. In other words, if wood or dirt particles lodge on the inside of the shaft, they are extremely difficult to dislodge. Therefore, this problem also remains to be solved.

There also remains a need for a device and method that can effectively anchor watercrafts and other water equipment to the shore or to assist in freeing a vehicle that is stuck in mud or rocks. Further, another need remains to anchor or safely tether animals.

Still yet another need remains for the ability to easily retrieve wedges and accessories that are embedded the ground.

The present invention seeks to solve the problems discussed above, as well as other problems.

### SUMMARY OF EXAMPLE EMBODIMENTS

The present disclosure is directed to mechanical, hand-driven wood splitters and earth anchors. In one embodiment, a multi-function slide hammer comprises a wood-splitting wedge, a guide rod, and at least two handles connected to a sleeve that is slidable on the guide rod; wherein the handles are joined to the sleeve at a lower end and an upper end of the sleeve.

In another embodiment, a multi-function slide hammer comprises an earth wedge, a guide rod, and at least two handles connected to a sleeve that is slidable on the guide rod. In one embodiment, the handles run parallel to, and are connected with, the sleeve for substantially the length of the sleeve. In another embodiment, the handles are joined to the sleeve directly at a lower end and at an upper end of the sleeve via stabilizers. In one method of use, a user will pound the earth wedge into the earth and tether a watercraft thereto.

In another embodiment, a multi-function slide hammer comprises an animal-anchoring wedge, a guide rod, and at least two handles connected to a sleeve that is slidable on the guide rod; wherein the handles are joined to the sleeve at a lower end and an upper end of the sleeve. In one method of use, a user will pound the animal-anchoring wedge into the earth and tether an animal thereto.

In yet another embodiment, a multi-function slide hammer comprises interchangeable components and accessories for various uses.

### BRIEF DESCRIPTION OF THE DRAWINGS

The drawings included herein depict only typical embodiments of the invention and are not therefore to be considered limiting of its scope.

FIG. 1 is a perspective view of a multi-function slide hammer with a wood-splitting wedge;

FIG. 2 is a front view of a multi-function slide hammer with a wood-splitting wedge;

FIG. 3 is a side view of a multi-function slide hammer with a wood-splitting wedge;

FIG. 4 illustrates the top views of a multi-function slide hammer with a wood-splitting wedge;

FIG. 5 illustrates the bottom views of a multi-function slide hammer with a wood-splitting wedge;

FIG. 6 shows a multi-function slide hammer with a wood-splitting wedge in use on a log;

FIG. 7 is a front view of a multi-function slide hammer with an earth anchor;

FIG. 8 is a side view of a multi-function slide hammer with an earth anchor;

FIG. 9 illustrates the top views of a multi-function slide hammer with an earth anchor;

FIG. 10 illustrates the bottoms views of a multi-function slide hammer with an earth anchor;

FIG. 11 shows a front view of a multi-function slide hammer with an earth anchor with two flanges;

FIG. 12 shows a side view of a multi-function slide hammer with an earth anchor with two flanges;

FIG. 13 illustrates the top views of a multi-function slide hammer with an earth anchor with two flanges;

FIG. 14 illustrates the bottom views of a multi-function slide hammer with an earth anchor with two flanges;

FIG. 15 shows a multi-function slide hammer with an earth anchor with four flanges tethered to a boat;

FIG. 16 shows a multi-function slide hammer with an earth anchor with two flanges tethered to a boat;

FIG. 17 is a front view of a multi-function slide hammer with an animal-anchoring wedge;

FIG. 18 is a side view of a multi-function slide hammer with an animal-anchoring wedge;

FIG. 19 illustrates the top views of a multi-function slide hammer with an animal-anchoring wedge;

FIG. 20 illustrates the bottom views of a multi-function slide hammer with an animal-anchoring wedge;

FIG. 21 shows a horse tethered to a multi-function slide hammer with an animal-anchoring wedge;

FIG. 22 shows a dog tethered to a multi-function slide hammer with an animal-anchoring tube wedge;

FIG. 23 is a front view of a multi-function slide hammer with an animal-anchoring tube wedge;

FIG. 24 is a side view of a multi-function slide hammer with an animal-anchoring tube wedge;

FIG. 25 illustrates the top views of a multi-function slide hammer with an animal-anchoring hollow tube wedge;

FIG. 26 illustrates the bottom views of a multi-function slide hammer with an animal-anchoring tube wedge;

FIG. 27 shows a fence post accessory for a multi-function slide hammer;

FIG. 28 shows a sign accessory for a multi-function slide hammer;

FIG. 29 shows a table accessory for a multi-function slide hammer;

FIG. 30 shows a bar for tying or otherwise securing items thereto for a multi-function slide hammer;

FIG. 31 shows a tubular receiver for umbrella posts or similar items for a multi-function slide hammer;

FIG. 32 shows a volleyball net accessory for a multi-function slide hammer;

FIG. 33 shows a feeding container accessory for a multi-function slide hammer;

FIG. 34 shows an accessory having multiple feeding/watering containers for a multi-function slide hammer;

FIG. 35 shows a multi-function slide hammer with removable wedge for use as stakes;

FIGS. 36A-E show a variety of multi-function slide hammers with removable wedges/tips;

FIGS. 36F-I show a variety of removably attachable wedges for use with a multi-function slide hammer;

FIG. 36J shows a top view of the multi-function slide hammer of FIG. 36E;

FIG. 37A shows a front view of a multi-function slide hammer for breaking the bead of a tire;

FIG. 37B shows a side view of a multi-function slide hammer for breaking the bead of a tire;

FIG. 38A shows a perspective view of a multi-function slide hammer for both inserting and removing a T-post into the ground;

FIG. 38B shows a side view of a multi-function slide hammer for use with T-posts and/or other similar posts;

FIG. 39 shows an alternative design of multi-function slide hammer;

FIG. 40 shows a multi-function slide hammer with a feeding/watering accessory thereon;

FIG. 41A illustrates the feeding/watering accessory for use with a mutli-function slide hammer;

FIG. 41B illustrates a sectional view of the feeding/watering accessory on a multi-function slide hammer; and

FIG. 42 illustrates a sectional view of the feeding/watering accessory on an alternative embodiment of the multi-function slide hammer.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrases “in one embodiment,” or “in an embodiment,” does not necessarily refer to the same embodiment, although it may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

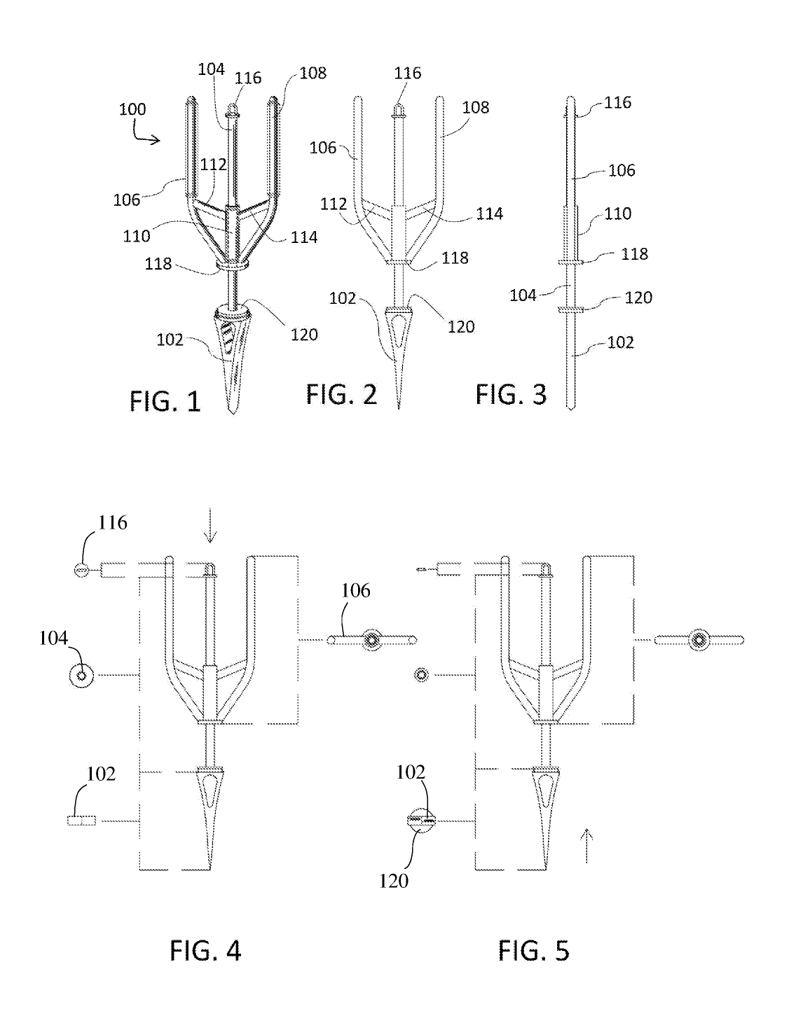

The present disclosure is directed to mechanical, hand-driven splitters and earth anchors. In one embodiment, as shown in FIGS. 1-6, the multi-function slide hammer 100 comprises a wood-splitting wedge 102, a guide rod 104, and at least two handles 106, 108 connected to a sleeve 110 that is slidable on the guide rod 104. Stabilizers 112, 114 add additional support to handles 106, 108 to prevent them from bending when force is applied and can also act as secondary handles should a user desire. Sleeve 110 can rotate freely on guide rod 104, allowing a user to use the multi-function slide hammer 100 from any angle they desire. Further, due to its compact size and control, a relatively small working space is needed. This also allows the entire multi-function slide hammer 100 to be tilted at any workable angle, as needed by the user. Further, the hammer sleeve assembly (which comprises handles 106, 108, sleeve 110, stabilizers 112, 114, and sleeve base 118) may be interchangeable to suit the needs of the user. In other words, stopper 116 may be removed (e.g., unscrewed) which allows the hammer sleeve assembly to be removed. A user may then use a differing hammer sleeve assembly, such as one with longer, heavier handles. This allows for customization to fit each user and use (e.g., small logs vs. large logs). Further, the design of the handle-to-sleeve connection imparts additional benefits. For example, handles 106, 108 are directly connected to the sleeve base 118. As such, the downward force by a user is transferred directly into the wedge head 120 upon impact. This differs from the prior art, where the handles may be attached perpendicularly to a sleeve. This is a failure in the prior art, as the handles, and especially the near 90° angle used by many, absorb the force rather than it being transferred to a wedge or post, leading to mechanical failure (e.g., bent/warped handles) faster. In the alternative, if the handles maintain their shape, it is likely due to the strength of the materials used; however, this leads to a device that is very heavy and cumbersome for a user to both use and transport. As such, the current disclosure eliminates this problem by connecting the handles directly to the sleeve base at lesser than a 90° angle.

Further, the handles 106, 108 are longer than the sleeve 110. This allows the unit to be made using fewer materials, thereby saving cost in manufacture. It also allows the hands of a user to remain at a safe distance from the guide rod-sleeve interaction, thereby avoiding injury. These are qualities not found in the prior art.

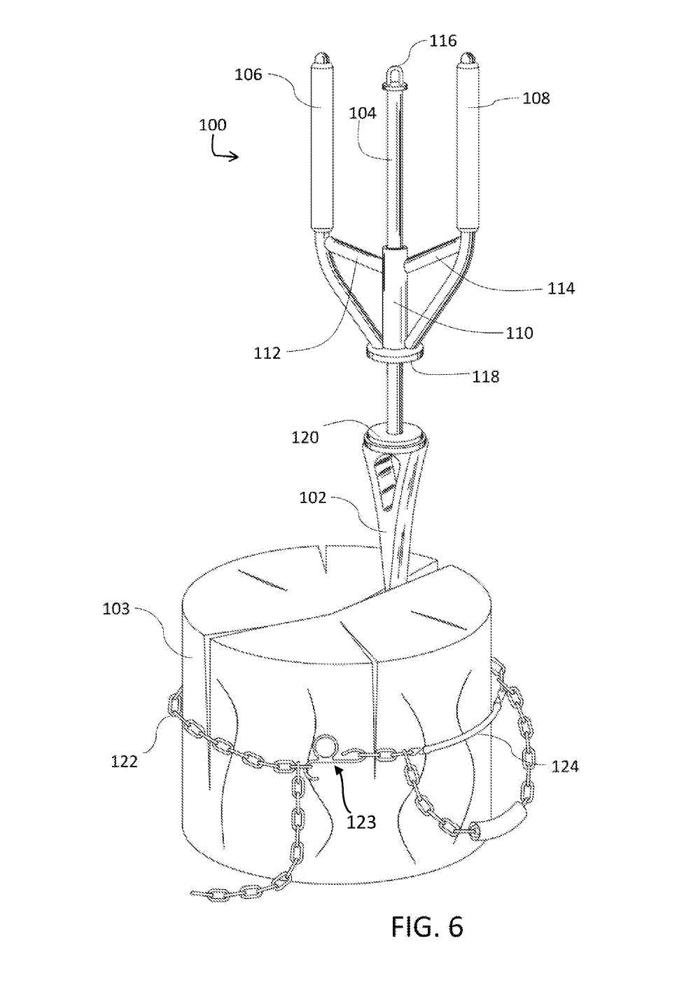

FIG. 6 shows an example of use of a multi-function slide hammer 100. As shown, the wood-splitting wedge 102 is placed on the log 103 for splitting. A user would then lift handles 106, 108 to just below the stopper 116, and then force the handles 106, 108 down via the guide rod 104 where the sleeve base 118 makes contact with the wedge head 120, forcing the wedge 102 downward into the log 103. This pounding process is repeated until the log 103 is split according to the desires of the user. As shown, additional accessories may also be used, such as a chain 122 with bungee 124 or equivalent (e.g., rope). This makes picking up and carrying the wood much easier as the split wood remains bundled together. Therefore, one method of splitting wood comprises the use of a wood splitter, which can be either manually actuated such as by using a multi-function slide hammer described herein or powered (e.g., pneumatic, electric, etc.), combined with the use of a chain and bungee wrapping around a log. Further, a quick release hook 123 may be used to quickly and easily attach and release the chain and bungee from the log, as best seen in FIG. 6.

As shown, sleeve 110 is preferably about one-fourth the length of the guide rod, providing the user with an ample stroke-length. The stroke-length is defined as the distance that the sleeve 110 is able to travel on the guide rod 104. In other words, the shorter the sleeve 102, the longer the stroke length. Although a one-fourth ratio is preferable, it is not required. The sleeve 110 may be shorter than one-fourth the length of the guide rod 104 or as long as about three-fourths of the length of the guide rod 104 without departing herefrom.

Unlike the prior art, handles 106, 108 are positioned substantially vertically adjacent to the guide rod 104 and are longer than the sleeve 110. This allows a user to maintain a good grip on the handles 106, 108 while reducing the force and whiplash experienced by a user. In other words, the downward force applied by a user is easily linearly transferred to the sleeve base 118 and to wedge head 120, creating minimal force and vibrations experienced by a user's hands. Further, it will be noted that the point of force transfer occurs at the sleeve base 118. In other words, the force is directly applied to the wedge head 120, eliminating the need for the force to travel down the guide rod 104 as taught by the prior art. By so doing, more force is applied to the log 103, allowing the log 103 (or rock or other object or surface) to be split with fewer strokes. Further, because the force impact point is at the wedge head 120, the user experiences less vibrations and feedback, creating a better user experience and lesser odds of mechanical failure.

Stopper 116 also creates additional uses and benefits not found in the prior art. For example, should the wedge 102 become undesirably lodged, the user may apply an upward force, striking the stopper with sleeve 110, which forces the wedge 102 upward, thereby aiding to dislodge or retrieve it. Additional benefits of this will be discussed below, in connection with earth anchors and other uses.

The multi-function slide hammer 100 may be made from various materials, including metals and plastics. For example, the wedge, handles, and guide rod may be made from steel or other metals. The guide rod and handles may be solid or hollow tubing. The handles may further comprise plastics, foams, or other materials for hand comfort.

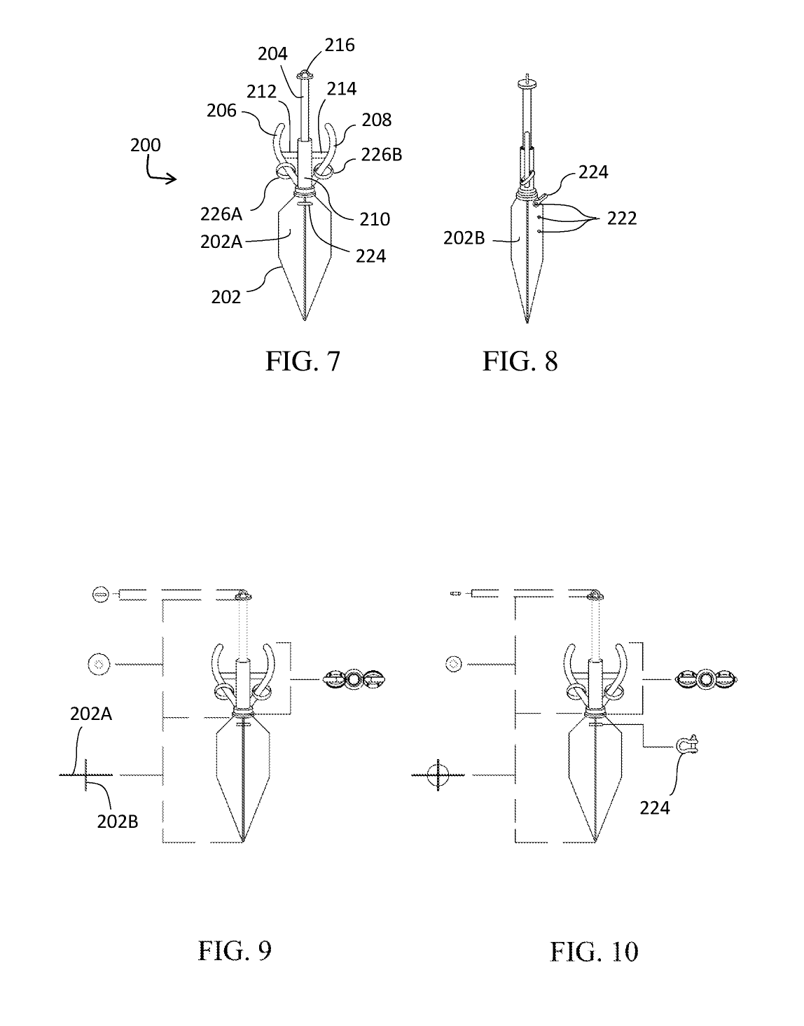

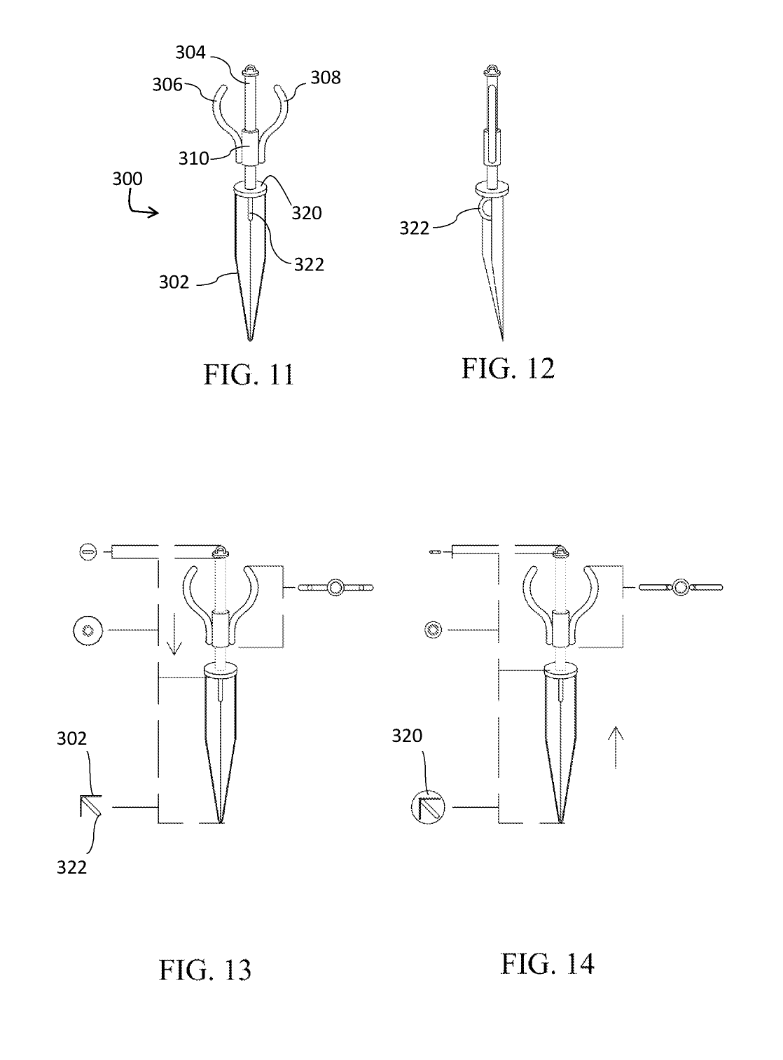

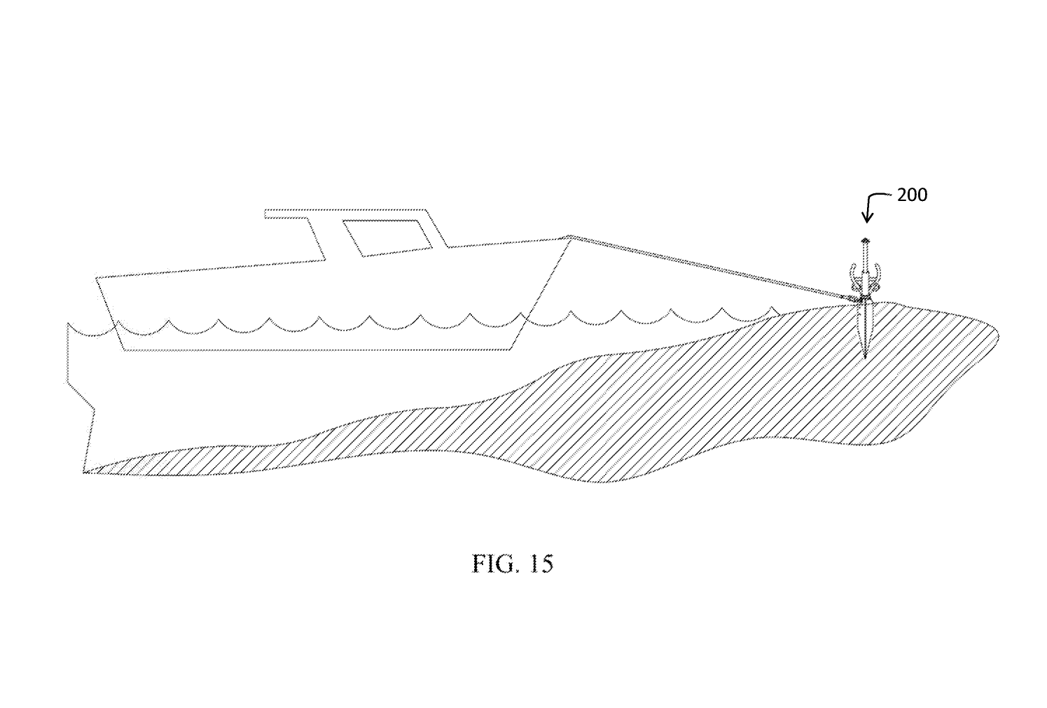

In one embodiment, as generally shown in FIGS. 7-10, a multi-function slide hammer 200 comprises an earth wedge 202, a guide rod 204, and at least two handles 206, 208 connected to a sleeve 210 that is slidable on the guide rod 204; wherein the handles 206, 208 are joined directly to the sleeve 210 at a lower end and via stabilizers 212, 214 at an upper end of the sleeve 210. The multi-function slide hammer 200 may further comprise at least one aperture 222 in the wedge 202 for passing a removably attachable ring 224 therethrough to act as a tethering connection. Additional rings 226A, 226B may be attached to the handles 206, 208 to act as additional tethering devices. For example, a carabiner may pass through the at least one aperture 222 or removably attachable ring 224 or rings 226A, 226B to secure a rope, chain, or other tether thereto. It will be appreciated that a carabiner is not required, and that a rope may simply be tied to the multi-function slide hammer 200. In one embodiment, as shown in FIGS. 11-14 and 16, a ring 322 may be directly connected to the wedge 302 of the multi-function slide hammer 300, either by welding or by being integrally formed therewith. As shown, it may be placed just below the wedge head 320, although placement on the wedge may vary. FIGS. 11-14 also illustrate an alternate embodiment for the handle-sleeve connection. In other words, handles 306, 308 run vertically along sleeve 310 for substantially the length of the sleeve 110 and are directly connected thereto. While the handles 306, 308 are illustrated as being connect to at least half of the sleeve length, such a long connection point is not required. However, a longer connection helps to avoid mechanical failure (i.e., the handles breaking free from the sleeve over time). FIGS. 11-14 also illustrate that a sleeve base is not required. Indeed, any of the sleeves described herein may or may not be coupled to a sleeve base. Further, the shape of the handles (i.e., circular in nature) help keep the hands clear of the guide rod 304 and sleeve 310 interaction.

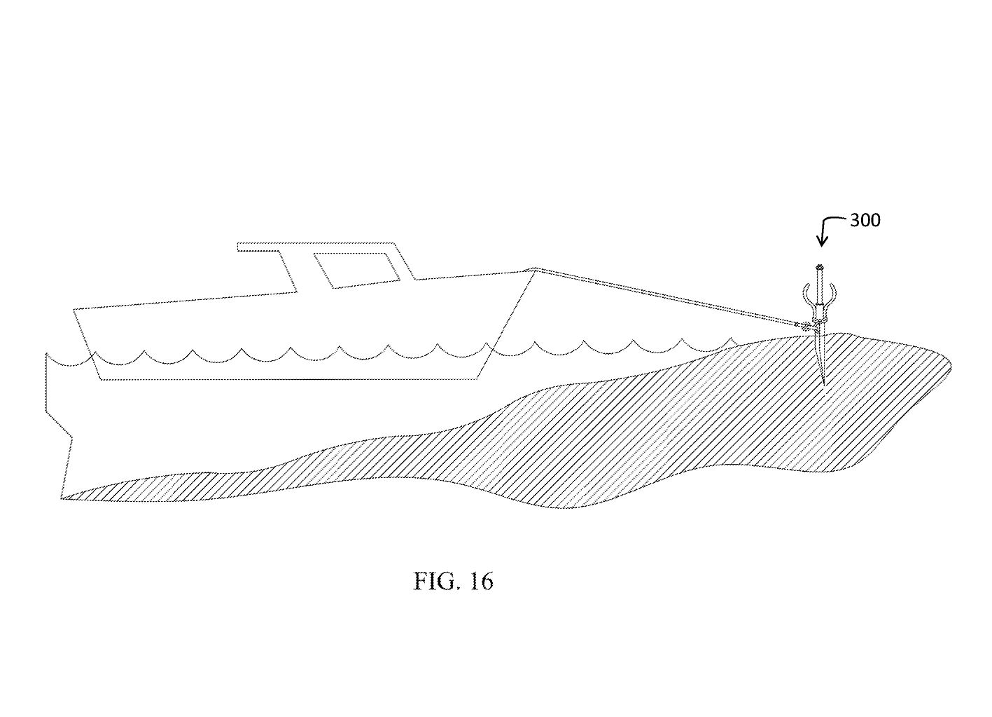

The earth wedge may be comprised of two (e.g., wedge 302 in FIGS. 11-14) or more (e.g., wedge 202 in FIGS. 7-10) flanges, which may or may not be the same width, as shown in FIGS. 7 and 8 where the side flanges 202A are wider than the front and back flanges 202B. The wider flanges 202A allow for more resistance in the direction of force, allowing for a greater anchoring capacity. In other words, FIG. 15 illustrates the multi-function slide hammer 200 with the wider, side flanges 202A perpendicular to the force (i.e., the boat). In one method of use, a user will pound the multi-function slide hammer 200 into the earth by raising the handles 206, 208 and forcing them down onto the wedge 202 repeatedly, until the wedge 202 is sufficiently subterranean, and will then tether a watercraft (or other object) thereto. FIG. 16 illustrates an example of a multi-function slide hammer 300 wherein the wedge 302 only has two flanges. It will be appreciated by those in the art that the flanges may be formed from one integral piece of metal or, in the alternative, may be individually welded together.

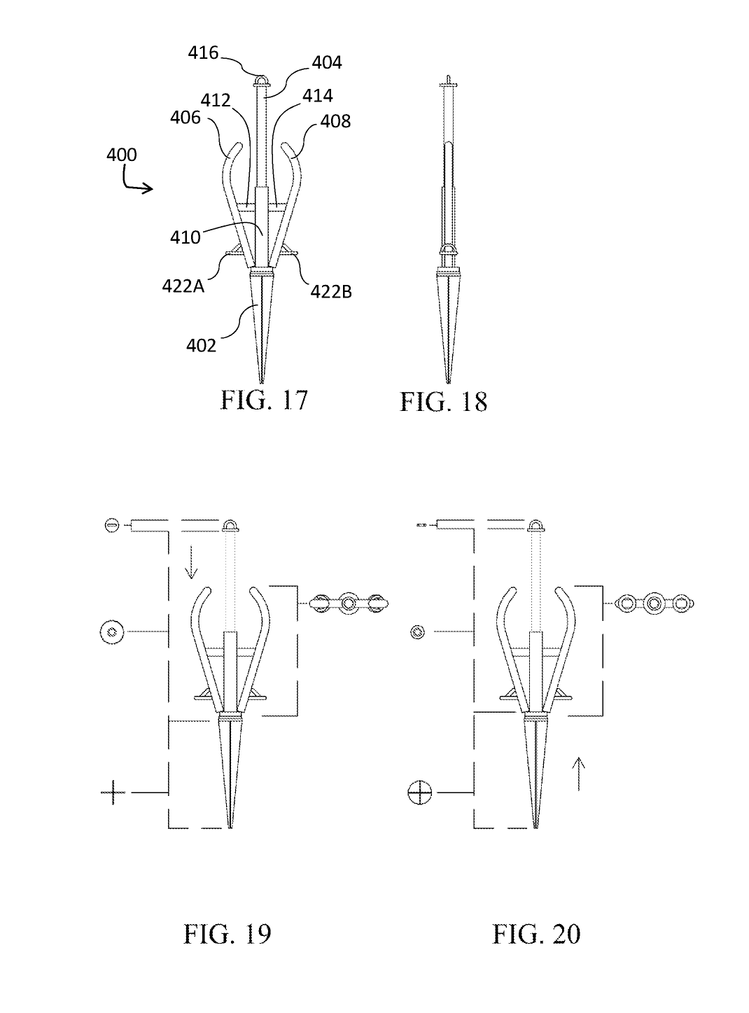

In another embodiment, as generally illustrated in FIGS. 17-20, a multi-function slide hammer 400 comprises an animal-anchoring wedge 402, a guide rod 404 with topper 416, and at least two handles 406, 408 connected to a sleeve 410 that is slidable on the guide rod 404; wherein the handles 406, 408 are joined directly to the sleeve 410 at a lower end and coupled to the sleeve 410 at an upper end via stabilizers 412, 414. One or more rings 422A, 422B may be connected or otherwise coupled to the handles 406, 408 to provide tethering connections. It will be appreciated that while the individual components are not labeled in FIGS. 18-20, that similarly drawn parts across views and across the embodiments impart similar functions.

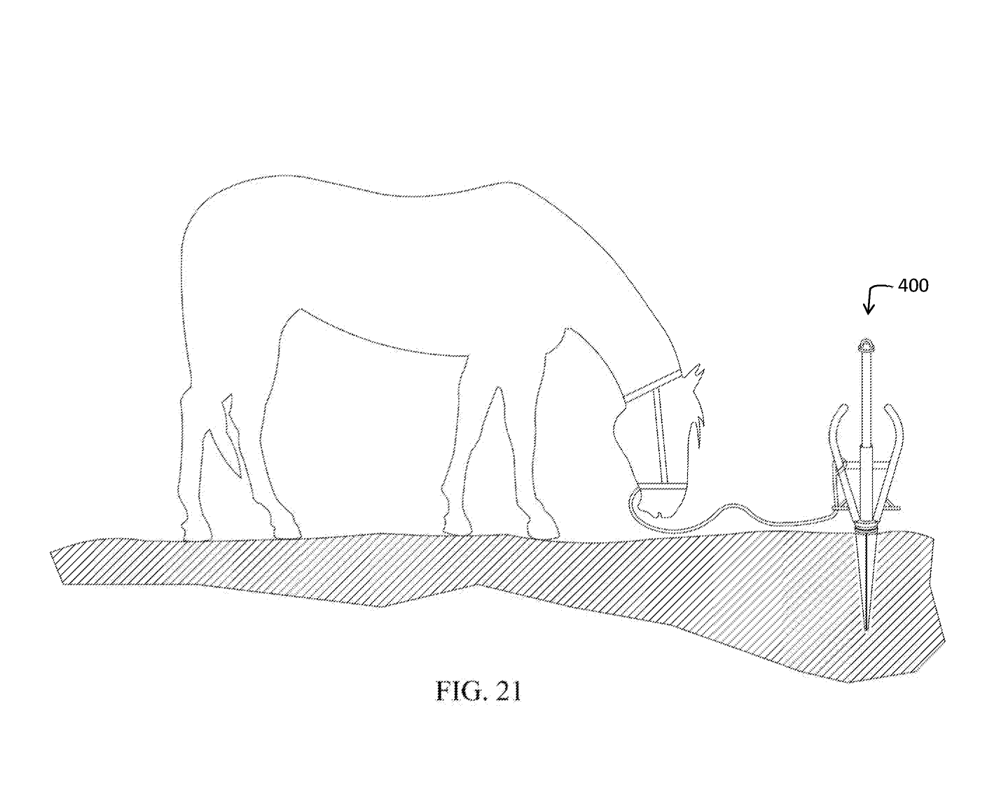

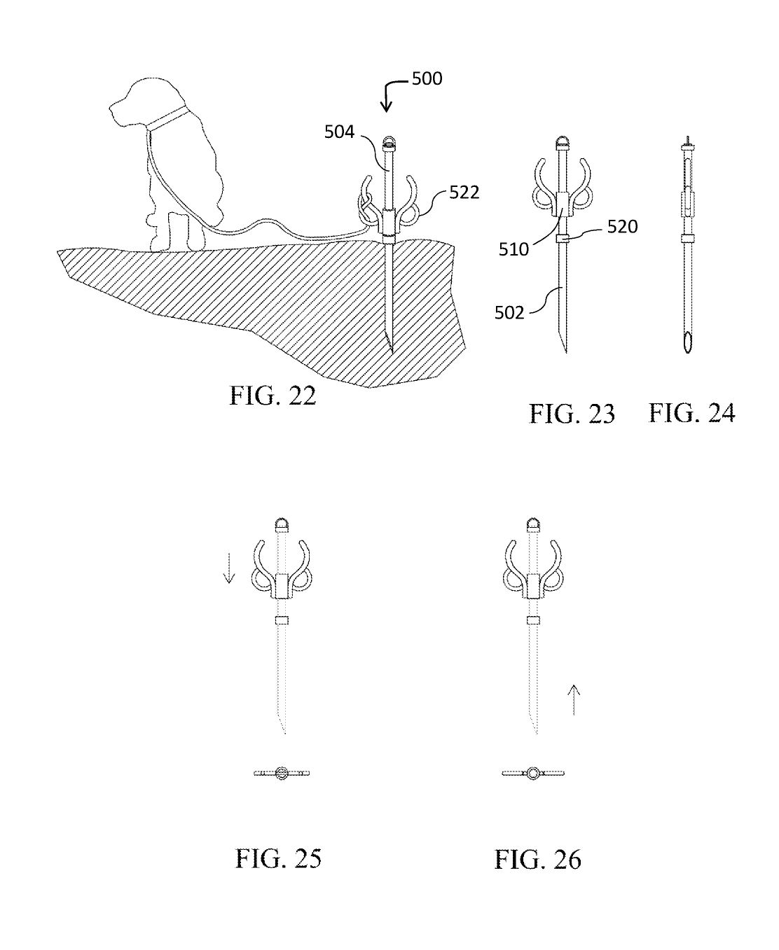

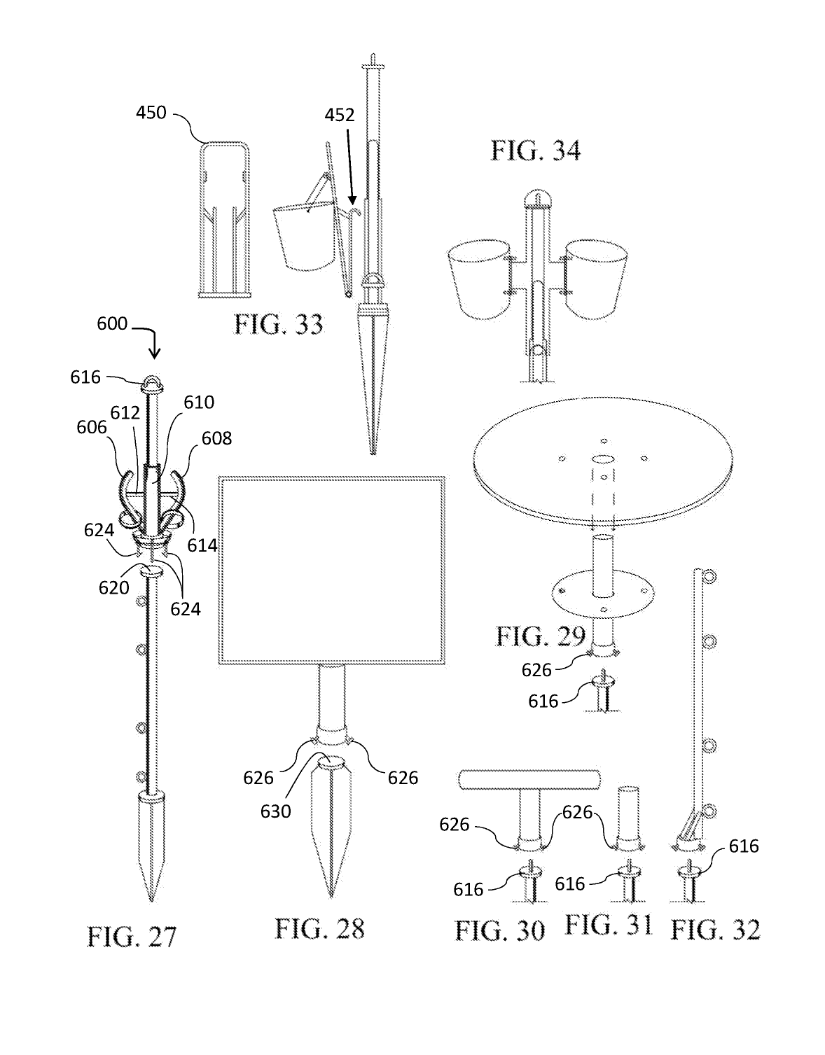

FIG. 21 illustrates a horse tethered to a multi-function slide hammer 400 with an animal-anchoring wedge 402. In another embodiment, as shown in FIGS. 22-26, an animal-anchoring wedge 502 of the multi-function slide hammer 500 may be a hollow tube cut at an angle to form a tip for penetrating the ground. The hollow tube is an improvement over the prior art because it allows earth to pass there-through, allowing for easier penetration of the soil. It also substantially reduces the cost of manufacturing, as a single cut in a tube can create two hollow tubes for use as an animal-anchoring wedge. In one embodiment, at least one ring 522 may be attached to the multi-function slide hammer 500, allowing for a rope, leash, chain (or equivalent) to be secured thereto. Because the sleeve 510 freely rotates on the guide rod 504, the animal is free to wander without the rope becoming easily entangled around the guide rod 504. Further, in one embodiment, the guide rod 504 and the animal-anchoring wedge 502 are one continuous tube with wedge head 520 being welded thereto. In another embodiment, the guide rod 504 is separate from wedge 502 and is coupled to the wedge via wedge head 520. It will be understood that while the multi-function slide hammer 500 comprises a tube-style wedge 502, it may alternatively comprise a wedge comprising a plurality of flanges. The flanges provide sufficient resistance in every direction such that an animal cannot withdraw the multi-function slide hammer from the ground.

As shown in FIGS. 33 and 34, a variety of accessories may be used so that the multi- function slide hammer also allows for food and/or water to be supplied to an animal. For example, container holder 450 has one or more hooks 452 for being placed over the stabilizers of any given embodiment described herein. FIG. 34 illustrates an alternative accessory, wherein the accessory has a hollow shaft for fully encompassing the guide rod and sleeve of any given embodiment.

In yet another embodiment, as generally shown in FIGS. 27-32 a multi-function slide hammer 600 comprises interchangeable wedges, tips, and accessories for various uses. For example, a plurality of accessories may be attached, whether permanently or removably, to a wedge, to a stopper 616, to handles 606, 608, or to the stabilizers 612, 614 of the multi-function slide hammer 600. This allows for a variety of functions, such as temporary fencing (e.g., fence post shown in FIG. 27), signs (FIG. 28), tables (FIG. 29), holding volleyball nets (FIG. 32), alternative tethers or signage (FIG. 30) and receiving shafts for things such as flagpoles (FIG. 31), as well as other functions, such as a shooting target.

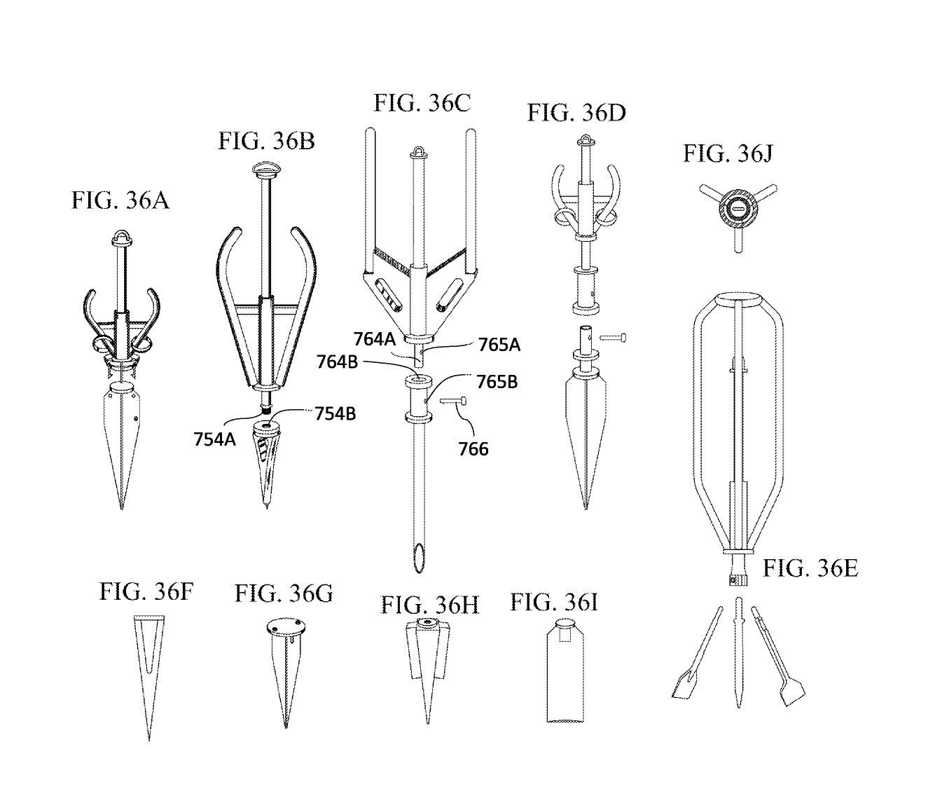

The ability to interchange the upper hammering assembly (which comprises the handles, sleeve (and in some instances sleeve base), and guide rod) for another object may be easily achieved through a variety of means. For example, quick-release hooks 624 (e.g., spring-loaded hooks that may be released by actuating the hook handle, causing a pivot which thereby disengages/decouples the hook from the surface) may be connected or otherwise coupled to the sleeve 610. A user may then engage quick-release hooks 624 to the wedge head 620. A user may then use the handles 606, 608 to pound the wedge to the desired depth. A user may then detach the upper hammering assembly by releasing the hooks 624. As shown in FIGS. 28-32, other items may then be attached either to the wedge, or to the stopper 616 of the guide rod, such as signs, tables, etc. as mentioned above. The components may either be coupled using the same means as the upper hammering assembly, or may use one or more set screws 626. For example, the component would receive the stopper 616 with the set screws being placed just below the stopper 616. The set screws 626 would then be tightened to the underside of the stopper 626. Other coupling methods may be used, such as those shown in FIGS. 36A-36J. For example, as generally shown in FIGS. 36A-J, various upper hammering assemblies may be coupled to a plurality of wedges/tips. For example, as seen in FIG. 36B, the upper hammer assembly and associated wedge(s) may comprise threaded portions 754A and 754B. As best seen in FIG. 36C, the upper hammer assembly may comprise a rod 764A for coupling to the wedge head via hollow shaft 764B. The locking pin 766 is then received through the apertures 765A and 765B. As shown in FIG. 36A, and as described in a prior embodiment, hooks may also be used. Other coupling mechanism may also be used such as twist and lock mechanisms that are well known in the arts as well as the quick release hexagon coupler (FIG. 36E) also well known in the art. It will be appreciated that other coupling means may be used without departing herefrom. In this manner, a user may replace a wedge or tip when worn out, or may simply interchange the wedge for another desired use, such as switching from a ground anchor wedge to a wood-splitting wedge to a stake, to any other use. Therefore, as described above, a means for coupling to a wedge or tip may comprise quick release hooks, threaded portions, locking pins, twist lock mechanisms, spring loaded-pins, and their equivalents.

FIGS. 36F-I illustrate various wedges and tips. In particular, FIG. 36G illustrates a spike useful for tying down tents or similar items, the figure illustrating a hook on the underside of the wedge head and one or more apertures on the wedge head. FIG. 36I illustrates a spade that is useful in the transplantation of trees and other plants.

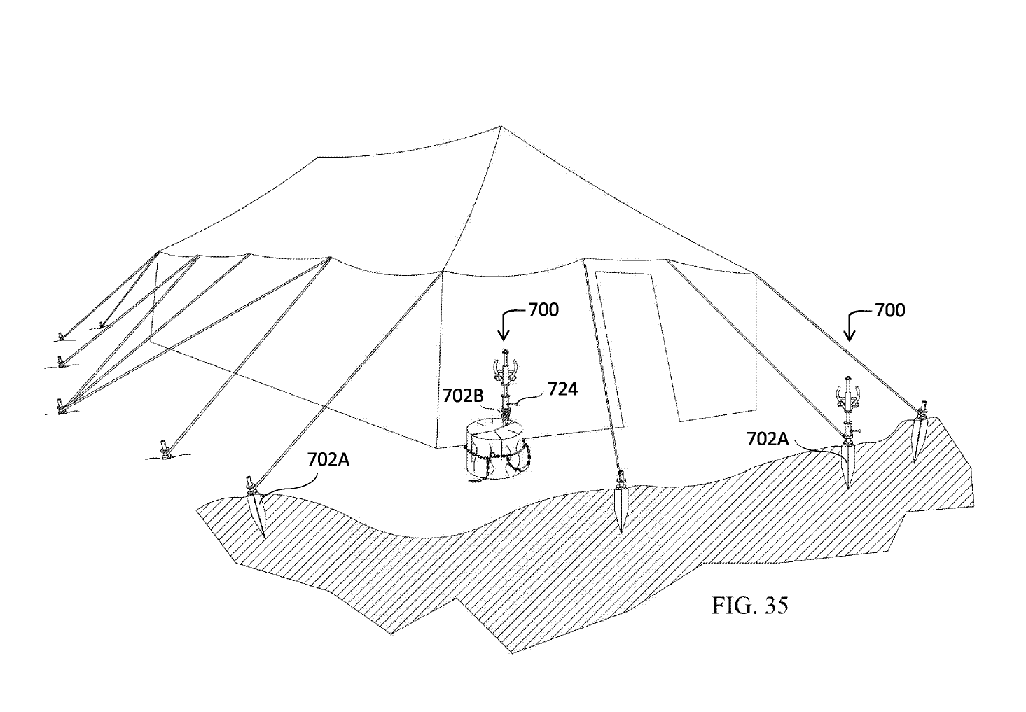

In one embodiment, returning to FIG. 35, the wedges 702A of a multi-function slide hammer 700 may function as individual stakes. For example, as seen in FIG. 35, a user may pound an earth wedge 702A into the soil, remove the upper hammer assembly (handles, sleeve, and guide rod) such as by releasing/withdrawing the locking pin 724, and tie a tent rope to the earth wedge 702A lodged in the ground. The upper hammer assembly may then be attached to another wedge, such as a wood-splitting wedge 702B, for splitting wood. This allows one multi-function slide hammer 700 to serve multiple functions. It may further be used for anchoring zip lines, rappelling, securing commercial event structures (e.g., tents, inflatables, etc.), hay tarping, and the like. This multi-use functionality is a large improvement over the prior art.

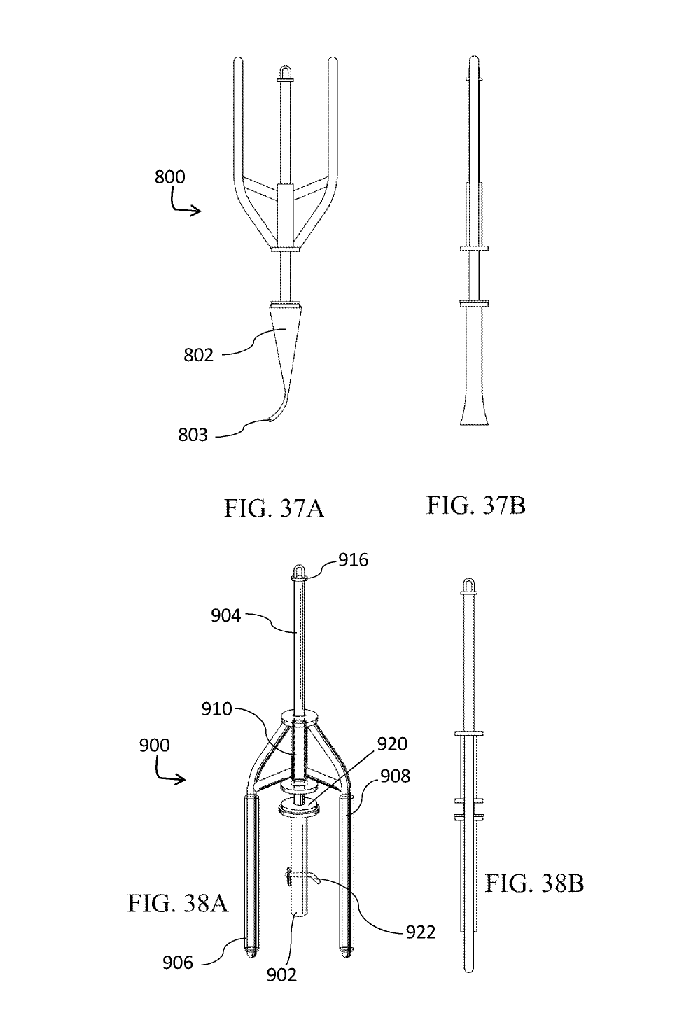

FIGS. 37A-B illustrate a multi-function slide hammer 800 having a bead breaking wedge 802 with a substantially curved tip 803. Due to the curved tip 803, the bead of a tire may be easily broken by a user.

FIGS. 38A-B illustrate a multi-function slide hammer 900 for use with T-posts. In other words, no wedge is used. Rather, a T-post is inserted into the hollow shaft 902 (while pin 922 is withdrawn). A user then lifts the handles 906, 908 so that the sleeve 910 raises along the guide rod 904 and slams it down repeatedly on the hollow shaft head 920 until the desired depth is reached. As an improvement over the prior art, the multi-function slide hammer 900 may also be used to remove a T-post. For example, hollow shaft 902 is placed over the desired T-post for removal. The user then inserts a locking pin 922, which rests between two protruding nodules on the T-post. A user is then able to repeatedly thrust the sleeve upwards against the stopper 916 until the T-post is withdrawn from the ground. Indeed, all of the embodiments disclosed herein have the ability to be bi-directionally used. In other words, if a user desires to withdraw any given wedge or tip, a user may simply thrust the handles upward until the sleeve hits the stopper, thereby withdrawing the wedge or tip.

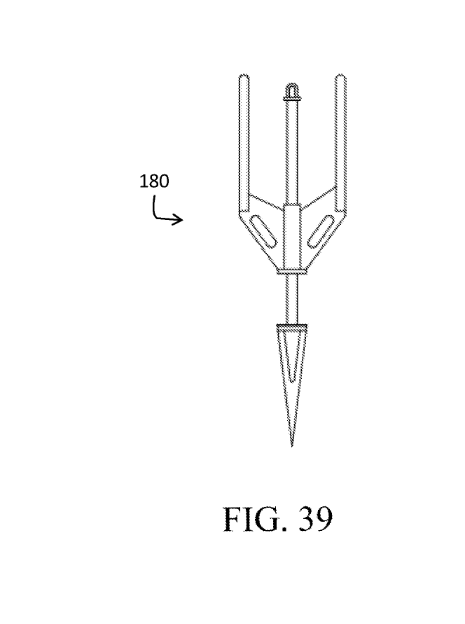

FIG. 39 illustrates a multi-function slide hammer 180 comprising an alternative form-factor for the sleeve-handle connection.

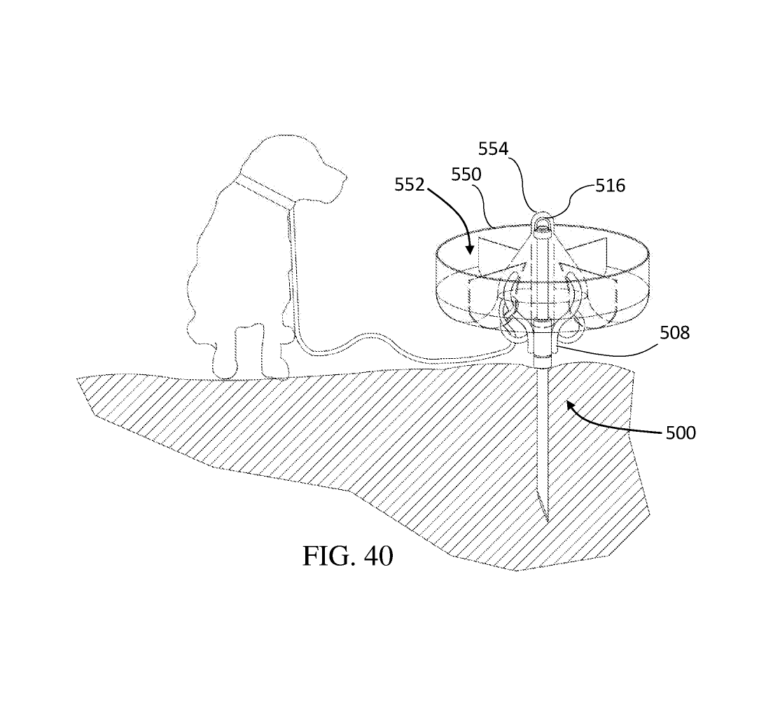

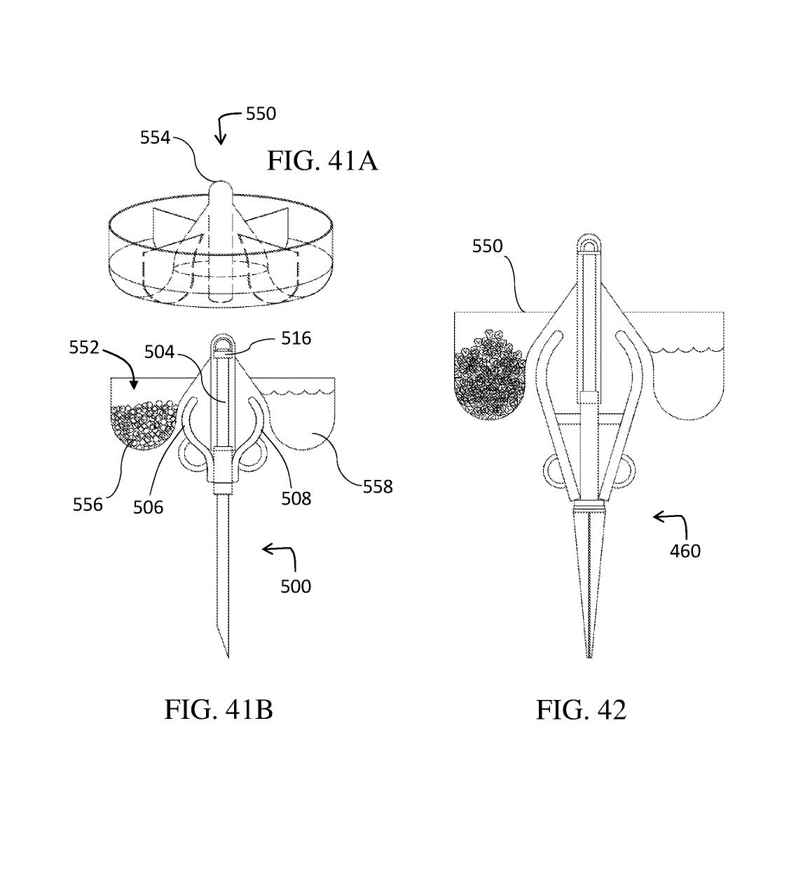

FIGS. 40-41B illustrate an animal feeding and watering apparatus 550 that may be used as an accessory to a multi-function slide hammer 500. For example, the animal feeding and watering apparatus 550 may comprise a hollow shaft for placement over the guide rod 504 and stopper 516 of multi-function slide hammer 500. The animal feeding and watering apparatus 550 comprises one or more compartments 552 for food and/or water. As shown in the cross-section of FIG. 41B, the animal feeding and watering apparatus 550 is formed so as to not come into contact with the handles 506, 508. This allows the handles 506, 508 to spin freely with the sleeve on the guide rod, allowing the tethered animal to move around without becoming entangled. FIG. 42 illustrates that one or more embodiments of a multi-function slide hammer may be used. In both examples, the guide rod cover 554 slides over the guide rod 504 and rests on the stopper 516. Because the stopper 516 is circular, the animal feeding and watering apparatus 550 can rotate thereon as needed.

It will be noted that there are many benefits to using a multi-function slide hammer as disclosed herein. For example, because the sleeve is slidable on the guide rod, and is open on both the top and the bottom, it allows for debris and other build-up to pass through, thereby not jamming or otherwise affecting the sliding motion. It also allows any moisture to easily evaporate, thereby avoiding corrosion. Another benefit includes the ability to pound both up and down. In other words, the handles may be pulled upwards to hit the stopper and thereby help dislodge the wedge from its location—whether that be in wood or in the ground.

Another beneficial use of the multi-function slide hammer is the ability to assist in dislodging vehicles when stuck. For example, a vehicle with a winch needs something to anchor to in order to pull itself out. The wedge may be driven into the ground, tethered to the vehicle using a winch, and thereby assist the vehicle in becoming dislodged.

The design and length of the handles and their combination with the sleeve allows for maximum stroke length as well as the most efficient transfer of energy. When force is applied using the present invention, the transfer of energy goes directly to the wedge due to the impact point being the bottom of the sleeve (or sleeve base) and the top of the wedge—the energy does not get lost due to travel length. This overcomes limitations in the prior art, where the impact point is at the top of a pole, requiring the energy to travel the length of the pole before reaching the wedge and its tip. The present disclosure provides for an impact point that is directly on the wedge, maximizing use of energy. Further, handles that are perpendicular to the wedge, such as in prior art, may cause damage to the hands and arms due to the impact when forced down. However, the present disclosure illustrates handles that are at an acute angle to the sleeve and guide pole. This creates less pressure and impact on the hands and arms when pounding. In at least one embodiment, there is a benefit to having the handles longer than the sleeve because it reduces the material used to construct the apparatus while still allowing for an aggressive, yet user friendly experience. In another embodiment, the handles may also be longer than the guide pole. This keeps the hands clear of the sleeve/guide pole interaction, lessening the odds for injury during use. It will also be appreciated that the sleeve, as referenced in the various embodiments, may be weighted so as to create additional force when pounding. This may be accomplished by adding weighted materials, altering fabrication materials, thickening the size of the sleeve, or by doing the same to the connected handles.

As seen throughout the Figures, the wedges may or may not be curved/tapered in nature. The concave/tapered wedge allows for easier penetration and higher splitting pressures as the wedge progresses in both wood, earth, rocks, and other surfaces.

Still yet other benefits are found in the present disclosure. For example, as disclosed herein, when the sleeve impacts the wedge head it is rare that the opposing sides of the contact point will hit all at the same time. One side of the sleeve will most likely impact before the other, causing a rotational whiplash of the sleeve. This whiplash then applies a sideways force to the guide rod and can lead to material stress, causing metal fatigue and breakage. The shorter the sleeve is, the closer the guide rod side impact point is to the wedge head, the closer the sideways force impact point is to the wedge head and less leverage force and stress fatigue is created by the rotational whiplash.

Other benefits include the ability of multiple users to use one multi-function slide hammer. For example, with a multi-function slide hammer disclosed herein, two users may simultaneously grip a handle for pounding. In other embodiments, such as shown in FIG. 36E, up to three persons may comfortably use the device. This allows large workloads to be more easily worked and also allows for the size of the multi-function slide hammer to increase significantly in size, as may be required for large jobs. The 3-handle system of FIG. 36E is also beneficial for protecting the guide rod when not in use. It also is well-suited to being carried in a horizontal position by one of the handles.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention as defined in the appended claims. Additionally, it is not intended that the scope of patent protection afforded the present invention be defined by reading into any claim a limitation found herein that does not explicitly appear in the claim itself.

What is claimed is:

1. A multi-function slide hammer, comprising:
a wedge comprising a guide rod attached to the top thereof and extending vertically therefrom;
a hammer sleeve assembly comprising a sleeve for receiving the guide rod,
wherein the sleeve comprises a base that engages and impacts the wedge and
wherein at least two handles are connected to the base of the sleeve, the handles extending at an acute angle therefrom and formed so as to be substantially parallel to the guide rod; and
a stopper mounted on the top of the guide rod.

2. The multi-function slide hammer of claim 1, further comprising one or more stabilizers extending from the upper portion of the sleeve to the handles.

3. The multi-function slide hammer of claim 1, wherein the wedge comprises a plurality of flanges.

4. The multi-function slide hammer of claim 1, further comprising a ring for tethering thereto.

5. The multi-function slide hammer of claim 1, further comprising an accessory coupled to the stopper.

6. The multi-function slide hammer of claim 1, wherein the sleeve is shorter in length than the handles.

7. The multi-function slide hammer of claim 1, wherein the stopper is removably attachable.

8. The multi-function slide hammer of claim 7, wherein the hammer sleeve assembly may be removably coupled to the guide rod.

9. The multi-function slide hammer of claim 1, wherein the wedge is a hollow tube.

10. A method of using a multi-function slide hammer of claim 1 to tether objects, comprising hammering a wedge into a surface using a multi-function slide hammer and tethering an object to the multi-function slide hammer.

11. The method of using a multi-function slide hammer to tether objects of claim 10, wherein the object is an animal.

12. The method of using a multi-function slide hammer to tether objects of claim 10, wherein the object is a watercraft, ATV, or vehicle.

13. The method of using a multi-function slide hammer to tether objects of claim 10, wherein the multi-function slide hammer comprises a feeding and watering accessory that fits over the stopper, guide rod, and handles.

14. A multi-function slide hammer, comprising:
an upper hammering assembly comprising a guide rod received within a sleeve, the sleeve comprising at least two handles extending therefrom, and a means for coupling to a wedge or tip; and
wherein the handles are connected to the base of the sleeve, the handles extending at an acute angle therefrom and formed so as to be substantially parallel to the guide rod.

15. The multi-function slide hammer of claim 14, wherein one or more accessories are removably attachable to the wedge.

16. A method of using the multi-function slide hammer of claim 14, comprising:
coupling the upper hammering assembly to a wedge;
hammering the wedge repeatedly by raising the sleeve via the handles and forcing the sleeve downward until it hammers the top of the wedge; and
removing the upper hammering assembly from the wedge once the wedge is sufficiently lodged in the surface.

17. The method of claim 16, further comprising attaching an accessory to the top of the wedge.

18. The method of claim 17, wherein the accessory comprises a fence post, sign, shooting target, or table.

19. A method of splitting wood, comprising:
coupling a chain and bungee around a log to be split;
placing a wood splitter on the log; and
repeatedly actuating the wood splitter until the log is desirably split.

20. The method of claim 19, wherein the wood splitter is a multi-function slide hammer.

21. The method of claim 19, wherein the wood splitter is pneumatic, electric, or gas powered.
